(19) United States
(12) Patent Application Publication
(10) Pub. No.: US 2005/0073468 A1
(43) Pub. Date: Apr. 7, 2005

(54) Multi-monitor system performing multi-display function by way of integrated graphics chipset

(75) Inventors: Macalas Yen, Taipei (TW); Jiing Lin, Taipei (TW); Wen-Lung Hsu, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Via Technologies, Inc., Taipei (TW)

(21) Appl. No.: 10/379,955

(22) Filed: Mar. 5, 2003

(30) Foreign Application Priority Data
May 15, 2002 (TW) 091110179

(51) Int. Cl. G09G 5/00

(52) U.S. Cl. 345/1.1

(57) ABSTRACT

A multi-monitor system includes a first and a second monitors, a graphics chipset and an AGP unit. The graphics chipset is integrated therein a graphics processing unit electrically connected to the first monitor and transmits: a first image signal to the first monitor for display. The AGP unit is electrically connected to the graphics chipset and the second monitor, receives a second image signal from the graphics chipset and transmit the second image signal to the second monitor for display.

### FIELD OF THE INVENTION

The present invention relates to a multi-monitor system, and more particularly to a multi-monitor system performing a multi-display function by way of an integrated graphics chipset.

### BACKGROUND OF THE INVENTION

A multi-monitor system is now well developed to show a plurality of images at the same time with a single host computer. Although the associated technologies including operation system, graphics drivers and/or application programs are relatively mature, the improvement of graphics chipsets for the multi-monitor system is still unsatisfactory.

Referring to FIG. 1, a multi-monitor system 10 comprises an integrated graphics chipset 11, a first monitor 12, a PCI (Peripheral Connect Interface) unit 13, a second monitor 14, a system memory 15, a central processing unit 16 and a south bridge chipset 17. The integrated graphics chipset 11 incorporates therein a graphics processing unit 111 operated under an AGP (Accelerated Graphics Port) transmission mode, and connected to the first monitor 12. The PCI unit 13 comprises a PCI port 131 connected to the integrated graphics chipset 11, and a graphics control device 132 coupled to the PCI port 131 and connected to the second monitor 14. As is known to a person skilled in the art, each of the first monitor 12 and the second monitor 14 could be a standard CRT (cathode ray tube) display, DVI (digital video interactive) display or TV screen.

When the multi-monitor system 10 operates, the graphics processing unit 111 of the integrated graphics chipset 11 performs a graphics operation and outputs an image signal S1 to the first monitor 12 via an AGP transmission mode. The system memory 15 stores therein a GART (Graphics Address Remapping Table) which is provided for the integrated graphics chipset 11 to increase graphics processing speed under the AGP transmission mode. Especially for 3D graphics images, the processing speed and performance are largely enhanced. On the other hand, the PCI unit 13 outputs an image signal S2 to the second monitor 14 in a PCI protocol. In such way, the images could be simultaneously displayed in the first monitor 12 and the second monitor 14 so as to perform a multi-display function.

FIG. 2 is a schematic diagram illustrating the configuration of another conventional multi-monitor system. Such system 20 comprises an integrated graphics chipset 21, a first monitor 12, a PCI (Peripheral Connect Interface) unit 13, a second monitor 14, a system memory 15, a central processing unit 16, a south bridge chipset 17 and further an AGP (Accelerated Graphics Port) unit 18. The PCI unit 13 comprises a PCI port 131 and a graphics control device 132. Unlike the integrated graphics chipset 11 of FIG. 1, the AGP transmission mode inside the integrated graphics chipset 21 is disabled, and in stead, the AGP unit 18 is employed to transmit the image signal S1 to the first monitor 12. The AGP unit 18 comprises an AGP port 181 electrically connected to the integrated graphics chipset 21 and a graphics processing/controlling device 182 electrically connected to the AGP port 181 and the first monitor 12. The system memory 15 could also store a GART (Graphics Address Remapping Table) for the AGP unit 18 to perform a re-mapping operation under the AGP transmission mode. In this prior art, the graphics processing unit 211 of the integrated graphics chipset 21 is left unused.

For both of the above-mentioned conventional multi-monitor systems, a PCI unit 13 serves one of the transmission paths for the multi-display function. However, a PCI interface is getting eliminated from the competition in the market due to relatively low data transfer speed. In stead, an AGP interface is more popular than a PCI interface in current market. Therefore, it will be more and more difficult to support multi-display function by using a PCI unit as in the prior art.

### SUMMARY OF THE INVENTION

It is an object of the present invention to provide a multi-monitor system capable of performing multi-display function without the presence of the PCI unit.

It is another object of the present invention to provide a multi-monitor system making use of the graphics processing unit of the integrated graphics chipset even if it is disabled from the AGP transmission mode.

In accordance with an aspect of the present invention, there is provided a multi-monitor system. The multi-monitor system comprises a first and a second monitors, a graphics chipset and an AGP unit. The graphics chipset is integrated therein a graphics processing unit electrically connected to the first monitor and transmits a first image signal to the first monitor for display. The AGP unit is electrically connected to the graphics chipset and the second monitor, receives a second image signal from the graphics chipset and transmits the second image signal to the second monitor for display.

In an embodiment, each of the first and the second monitor is selected from a group consisting of a CRT display, a DVI display and a TV screen.

In an embodiment, the AGP unit includes an AGP port electrically connected to the graphics chip, and a graphics processing and controlling device electrically connected to the AGP port and the second monitor.

In an embodiment, the graphics processing unit normally operates under an AGP transmission mode.

In an embodiment, the first image signal is transmitted to the first monitor under the AGP transmission mode. Furthermore, the multi-monitor system further comprises a system memory electrically connected to the graphics chipset and storing therein two GARTs (Graphics Address Remapping Tables) for the AGP transmission to the first and the second monitors, respectively.

In an embodiment, the first image signal is transmitted to the first monitor under a simulated PCI transmission mode. Furthermore, the multi-monitor system further comprises a system memory electrically connected to the graphics chipset and storing therein a GART (Graphics Address Remapping Table) for the AGP transmission to the second monitor.

In an embodiment, the multi-monitor system further comprises a CPU electrically connected to the graphics chipset.

In an embodiment, the multi-monitor system further comprises a south bridge chipset electrically connected to the graphics chipset.

In accordance with another aspect of the present invention, there is provided a multi-monitor system. The multi-monitor system comprises an integrated graphics chipset, a first monitor and a second monitor. The first monitor is electrically connected to the integrated graphics chipset directly, and receives a first image signal from the integrated graphics chipset for display. The second monitor is electrically connected to the integrated graphics chipset via an AGP unit, and receives a second image signal from the integrated graphics chipset via the AGP unit for display.

In an embodiment, the integrated graphics chipset normally operates under an AGP transmission mode.

In an embodiment, the first signal is transmitted under an AGP transmission mode. Furthermore, the multi-monitor system further comprises a system memory electrically connected to the integrated graphics chipset and storing therein two GARTs (Graphics Address Remapping Tables) for the transmission to the first and the second monitors, respectively.

In an embodiment, the first signal is transmitted under a PCI transmission mode. Furthermore, the multi-monitor system further comprises a system memory electrically connected to the integrated graphics chipset and storing therein a GART (Graphics Address Remapping Table) for the transmission to the second monitor.

In accordance with another aspect of the present invention, there is provided a multi-monitor system. The multi-monitor system comprises a first and a second monitors, a graphics chipset and an AGP unit. The graphics chipset is integrated therein a graphics processing unit electrically connected to the first monitor and transmit a first image signal to the first monitor for display under a PCI transmission mode. The AGP unit is electrically connected to the graphics chipset and the second monitor, receives a second image signal from the graphics chipset and transmits the second image signal to the second monitor for display.

The above objects and advantages of the present invention will become more readily apparent to those ordinarily skilled in the art: after reviewing the following detailed description and accompanying drawings, in which:

### BRIEF DESCRIPTION OF THE DRAWINGS

FIG. 1 a schematic circuit block diagram illustrating a conventional multi-monitor system;

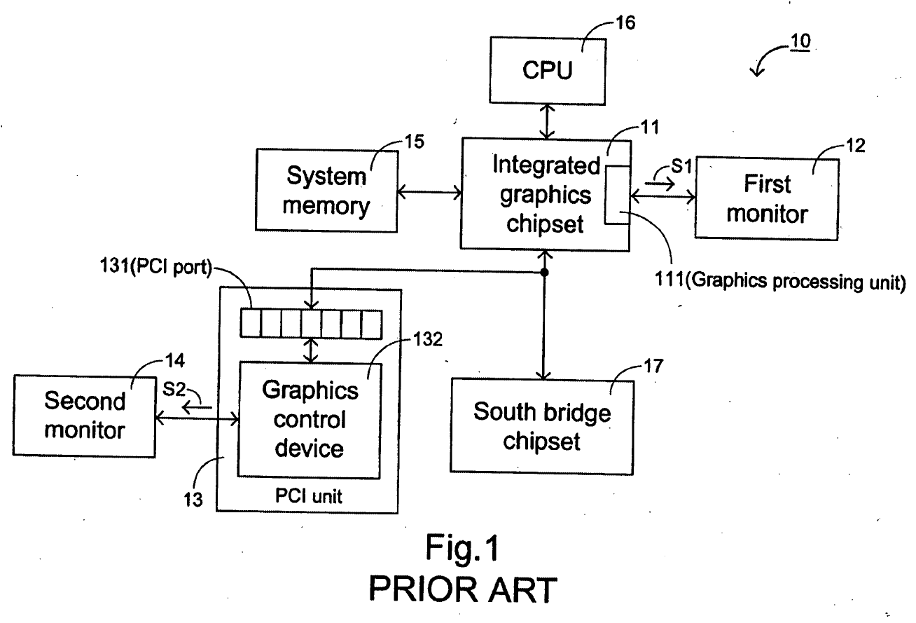

FIG. 2 a schematic circuit block diagram illustrating another conventional multi-monitor system; and

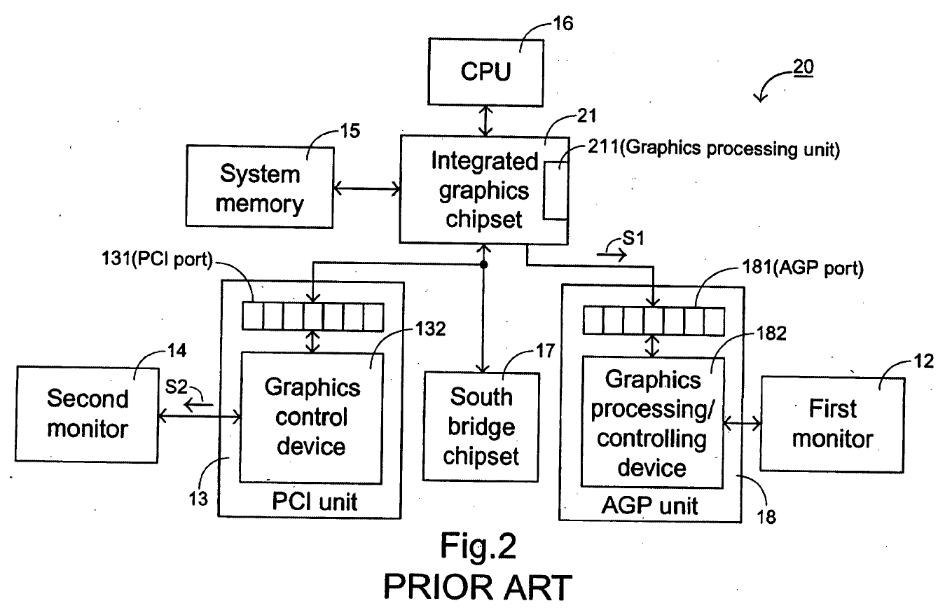

FIG. 3 is a schematic circuit block diagram illustrating a multi-monitor system according to a preferred embodiment of the present invention.

### DETAILED DESCRIPTION OF THE PREFERRED EMBODIMENT

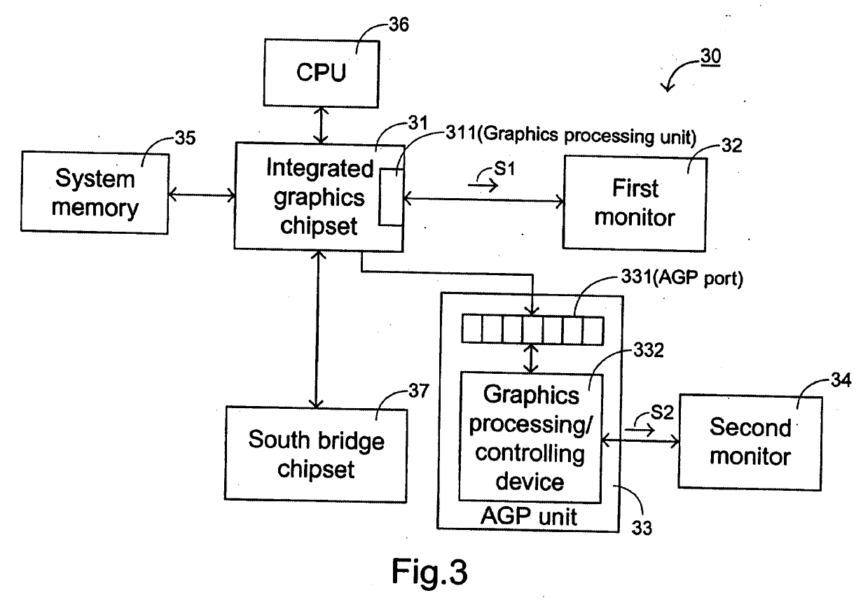

Please refer to FIG. 3, which illustrates a multi-monitor system according to a preferred embodiment of the present invention. The multi-monitor system 30 comprises an integrated graphics chipset 31, a first monitor 32, an AGP (Accelerated Graphics Port) unit 33, a second monitor 34, a system memory 35, a central processing unit 36 and a south bridge chipset 37. The integrated graphics chipset 31 incorporates therein a graphics processing unit 311 operated under an AGP (Accelerated Graphics Port) transmission mode, and connected to the first monitor 32. The AGP unit 33 comprises an AGP port 331 electrically connected to the integrated graphics chipset 31 and a graphics processing/controlling device 332 electrically connected to the AGP port 331 and the second monitor 34. For example, each of the first monitor 32 and the second monitor 34 could be a standard CRT (cathode ray tube) display, DVI (digital video interactive) display or TV screen.

For a system permitting two simultaneous AGP transmission modes, the graphics processing unit 311 of the integrated graphics chipset 31 is enabled to perform a graphics operation and outputs an image signal S1 to the first monitor 32 via an AGP transmission mode. The AGP unit 33 is employed to transmit an image signal S2 to the second monitor 34 via an AGP transmission mode. In such case, the system memory 35 preferably stores therein two GARTs (Graphics Address Remapping Tables) for the AGP transmission to the first monitor 32 and the second monitor 34, respectively. In such way, the images could be simultaneously displayed in the first monitor 32 and the second monitor 34 so as to perform a multi-display function.

On the contrary, for a system not permitting the co-presence of two AGP transmission modes, the AGP transmission mode inside the integrated graphics chipset 31 is disabled, the AGP transmission mode is switched into a simulated PCI transmission mode by the integrated graphics chipset 31. Thus, the image signal S1 is transmitted to the first monitor 32 via the simulated PCI transmission mode, i.e. in a PCI protocol. Likewise, the AGP unit 33 is employed to transmit an image signal S2 to the second monitor 34 via an AGP transmission mode. In such case, the system memory 35 preferably stores therein a GART (Graphics Address Remapping Table) for the AGP transmission to the second monitor 34. The GART facilitates increasing graphics processing speed of the integrated graphics chipset 31 under the AGP transmission mode. Especially for 3D graphics images, the processing speed and performance are largely enhanced.

It is understood that the PCI interface could be omitted by using the multi-monitor system of the present invention due to the switch from an AGP transmission mode into a simulated PCI transmission mode. Thus, the commercially available AGP interface could be used instead of the PCI interface so as to reduce related cost of providing a multi-monitor system.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A multi-monitor system comprising:
a first and a second monitors;
a graphics chipset integrated therein a graphics processing unit electrically connected to said first monitor and transmitting a first image signal to said first monitor for display; and
an AGP unit electrically connected to said graphics chipset and said second monitor, receiving a second image signal from said graphics chipset and transmitting said second image signal to said second monitor for display.

2. The multi-monitor system according to claim 1 wherein each of said first and said second monitor is selected from a group consisting of a CRT display, a DVI display and a TV screen.

3. The multi-monitor system according to claim 1 wherein said AGP unit includes an AGP port electrically connected to said graphics chipset, and a graphics processing and controlling device electrically connected to said AGP port and said second monitor.

4. The multi-monitor system according to claim 1 wherein said graphics processing unit normally operates under an AGP transmission mode.

5. The multi-monitor system according to claim 4 wherein said first image signal is transmitted to said first monitor under said AGP transmission mode.

6. The multi-monitor system according to claim 5 further comprising a system memory electrically connected to said graphics chipset and storing therein two GARTs (Graphics Address Remapping Tables) for the AGP transmission to said first and said second monitors, respectively.

7. The multi-monitor system according to claim 4 wherein said first image signal is transmitted to said first monitor under a simulated PCI transmission mode.

8. The multi-monitor system according to claim 7 further comprising a system memory electrically connected to said graphics chipset and storing therein a GART (Graphics Address Remapping Table) for the AGP transmission to said second monitor.

9. The multi-monitor system according to claim 1 further comprising a CPU electrically connected to said graphics chipset.

10. The multi-monitor system according to claim 1 further comprising a south bridge chipset electrically connected to said graphics chipset.

11. A multi-monitor system comprising:
an integrated graphics chipset;
a first monitor electrically connected to said integrated graphics chipset directly, and receiving a first image signal from said integrated graphics chipset for display; and
a second monitor electrically connected to said integrated graphics chipset via an AGP unit, and receiving a second image signal from said integrated graphics chipset via said AGP unit for display.

12. The multi-monitor system according to claim 11 wherein said integrated graphics chipset normally operates under an AGP transmission mode.

13. The multi-monitor system according to claim II wherein said first signal is transmitted under an AGP transmission mode.

14. The multi-monitor system according to claim 13 further comprising a system memory electrically connected to said integrated graphics chipset and storing therein two GARTs (Graphics Address Remapping Tables) for the transmission to said first and said second monitors, respectively.

15. The multi-monitor system according to claim 11 wherein said first signal is transmitted under a PCI transmission mode.

16. The multi-monitor system according to claim 15 further comprising a system memory electrically connected to said integrated graphics chipset and storing therein a GART (Graphics Address Remapping Table) for the transmission to said second monitor.

17. The multi-monitor system according to claim 11 further comprising a CPU and a south bridge chipset electrically connected to said integrated graphics chipset.

18. A multi-monitor system comprising:
a first and a second monitors;
a graphics chipset integrated therein a graphics processing unit electrically connected to said first monitor and transmitting a first image signal to said first monitor for display under a PCI transmission mode; and
an AGP unit electrically connected to said graphics chipset and said second monitor, receiving a second image signal from said graphics chipset and transmitting said second image signal to said second monitor for display.
